(19) United States
(12) Patent Application Publication
(10) Pub. No.: US 2004/0186990 A1
(43) Pub. Date: Sep. 23, 2004

(54) Method of e-mail encryption

(75) Inventors: Cheng-Shing Lai, Tapipei Hsien (TW); Chang Liu, Nanking (CN); Xiao-Long Fan, Nanking (CN)

Correspondence Address: BACON & THOMAS, PLLC, 625 SLATERS LANE, FOURTH FLOOR, ALEXANDRIA, VA, 22314

(73) Assignee: Inventec Appliances Corp., Taipei Hsien (TW)

(21) Appl. No.: 10/388,645

(22) Filed: Mar. 17, 2003

(51) Int. Cl. H04L 9/00

(52) U.S. Cl. 713/153

(57) ABSTRACT

The present invention is to provide a method of encrypting an e-mail comprising the steps of providing a safe connection server in a mail server and an address in a mobile communication device for accessing the mail server and establishing a virtual safe channel from the mobile communication device to the mail server in response to a sending or receiving of the e-mail from the mobile communication device over the Internet; encrypting the e-mail by adding an encryption key; and sequentially transmitting data contained in the encrypted e-mail over the virtual safe channel so as to carry out a normal e-mail sending or receiving via a mail processing module in the mobile communication device.

### FIELD OF THE INVENTION

The present invention relates to electronic mails (e-mails) and more particularly to a method of encrypting e-mails.

### BACKGROUND OF THE INVENTION

This is an information age particularly an e-world due to a rapid, spectacular development of electronics technology. Message communication among people has become even frequent. Further, communication speed has been increased significantly. As such, the Internet has been widely utilized by people and trades for meeting communication requirements. Moreover, mobile communication devices such as cellular phones have been widely used by people as an indispensable tool of daily life.

Conventionally, text contained in an e-mail sent over the Internet is a plain text (i.e., not enciphered). As such, it is easy for a third unauthorized person (e.g., hacker) to invade the Internet and overhear the sent e-mail. For an individual, such act may reveal personal secrets. For an enterprise, it is a serious safety threat. Hence, e-mail protection is very important.

Unfortunately, there is no available means provided by mobile communication device manufacturers for e-mail encryption. Hence, it is highly possible that an e-mail sent over the Internet is intercepted and overheard by the third unauthorized person.

Thus, it is desirable among the mobile communication device manufacturers to provide a method of encrypting e-mails in order to overcome the above drawback of the prior art.

### SUMMARY OF THE INVENTION

A primary object of the present invention is to provide a method of encrypting an e-mail comprising steps of providing a safe connection server in a mail server and an address in a mobile communication device for accessing the mail server; establishing a connection between the mobile communication device and the mail server in response to a sending or receiving of the e-mail from the mobile communication device over the Internet; activating the safe connection server so that the safe connection server is capable of determining whether an ID and an exchange encryption key are correct based on the address in the mobile communication device and a corresponding address of the mail server; establishing a virtual safe channel from the mobile communication device to the mail server; encrypting the e-mail by adding an encryption key; and sequentially transmitting data contained in the encrypted e-mail over the virtual safe channel so as to carry out a normal e-mail sending or receiving via a mail processing module in the mobile communication device. By utilizing this method, the purpose of protecting e-mails from being intercepted and/or overheard by a third unauthorized person while sending is achieved.

The above and other objects, features and advantages of the present invention will become apparent from the following detailed description taken with the accompanying drawings.

### BRIEF DESCRIPTION OF THE DRAWINGS

FIG. 1 presents a structure applicable for a preferred embodiment of the invention;

FIG. 2 presents a structure of encrypted e-mail according to the invention;

FIG. 3 is a flow chart illustrating a process performed by mobile communication device according to the invention; and

FIG. 4 is a flow chart illustrating a process performed by mail server according to the invention.

### DETAILED DESCRIPTION OF THE PREFERRED EMBODIMENTS

The invention is directed to a method of encrypting an e-mail comprising the steps of providing a safe connection server 11 in a mail server 10 and an address in a mobile communication device (e.g., cellular phone) 12 for accessing the mail server 10; establishing a connection between the mobile communication device 12 and the mail server 10 in response to a sending or receiving of the e-mail from the mobile communication device 12 over the Internet 13; activating the safe connection server 11 so that the safe connection server 11 is capable of determining whether an ID and an exchange encryption key are correct based on the address in the mobile communication device 12 and a corresponding address of the mail server 10; establishing a virtual safe channel from the mobile communication device 12 to the mail server 10; encrypting the e-mail by adding an encryption key; and sequentially transmitting data contained in the encrypted e-mail over the virtual safe channel so as to carry out a normal e-mail sending or receiving via a mail processing module 123 in the mobile communication device 12. As an end, the purpose of protecting e-mails from being intercepted and/or overheard by a third unauthorized person while sending is achieved.

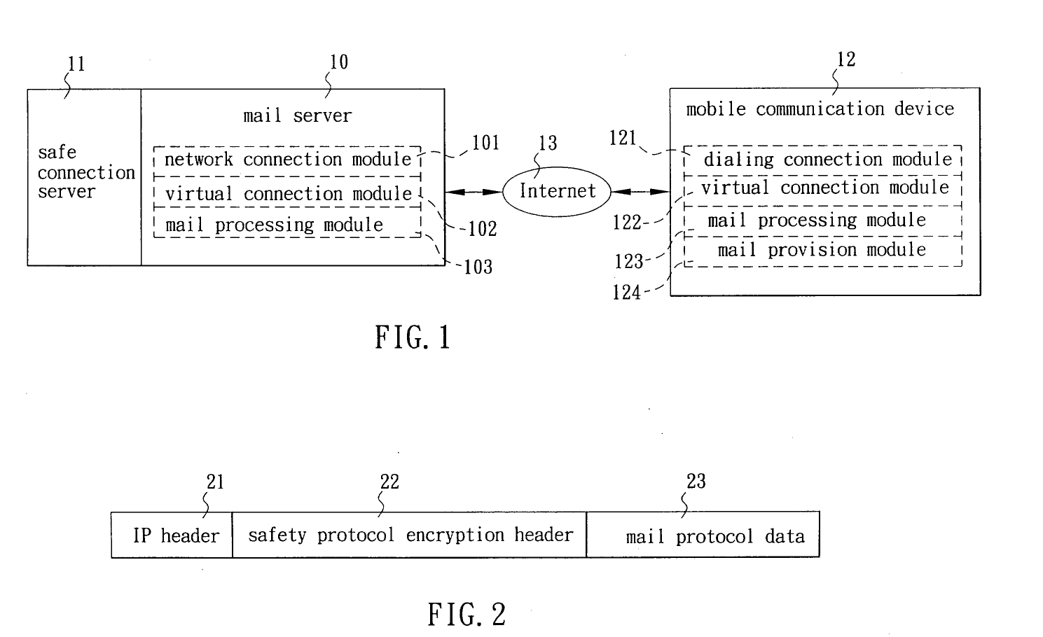

Referring to FIG. 1, there is shown a structure applicable for a preferred embodiment of the invention, which comprises a mail server 10 including a network connection module 101 for accessing the Internet 13, a virtual connection module 102 for establishing a safe connection with the mobile communication device 12 and maintaining the same, and a mail processing module 103 for processing e-mails; and a safe connection server 11 for providing and connecting to a safe channel. The safe connection server 11 may share a server 10 with the mail server 10. Further, a built-in safe connection module (not shown) of Windows 2000 can be used if the invention is operated under Windows operating system (OS). But the invention is not limited to Windows OS in practice. It is appreciated by those skilled in the art that Windows OS may be replaced by another suitable OS having compatible software for carrying out the invention. Thus a detailed description about this is omitted herein for the sake of brevity.

The structure of the invention further comprises the mobile communication device 12 for supporting a data dialing and an e-mail sending or receiving, the mobile communication device 12 includes a dialing connection module 121 for establishing an unsafe connection with the Internet 13, a virtual connection module 122 for establishing a safe connection with the mail server 10 and maintaining the same, a mail processing module 123 for sending or receiving e-mails, and a mail provision module 124 for providing messages about the mail server 10; and the Internet 13 for connecting the mail server 10 to the mobile communication device 12 thereover.

Referring to FIGS. 1 and 2, there is shown a structure of encrypted e-mail of the invention. Since data being transmitted over the Internet should be in a frame used as a data transmitting unit, data contained in an e-mail must be enveloped into packets prior to sending. After all the packets being received to form a complete e-mail, the information stored in predetermined addresses of the encrypted e-mail comprises an Internet protocol (IP) header 21, the IP header 21 being a data frame obtained by exchanging over the Internet 13, a safety protocol encryption header 22, the safety protocol encryption header 22 being a data frame of safe channel protocol formed by encrypting, and a mail protocol data 23, the mail protocol data 23 being an e-mail data formed by IP. Data content of each of the IP header 21, the safety protocol encryption header 22, and the mail protocol data 23 of the encrypted e-mail can be obtained by reading the respective predetermined address thereof.

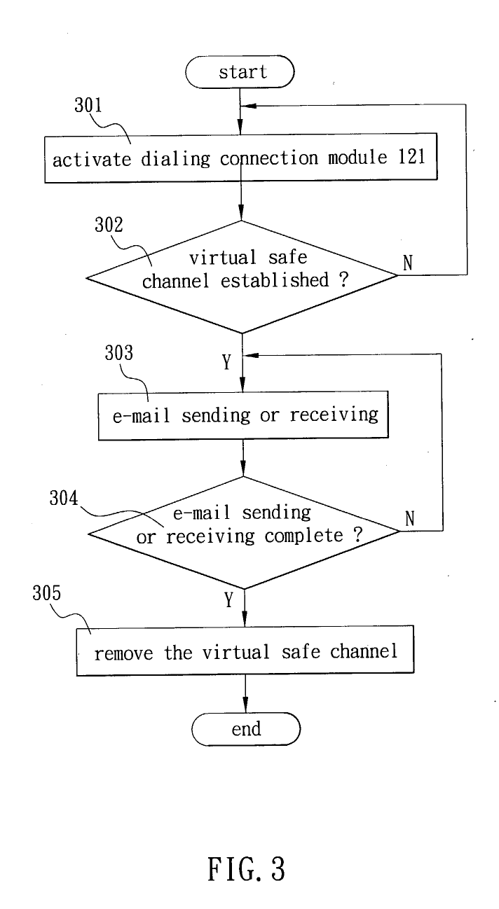

Referring to FIGS. 1 and 3, there is shown a flow chart performed by the mobile communication device 12 for sending or receiving an e-mail according to the invention. It comprises the following steps:

In step 301, first it activates the dialing connection module 121 to establish an unsafe dialing connection. In step 302, it is determined whether a virtual safe channel with the mail server 10 is established based on the address in the mobile communication device 12 via the virtual connection module 122. If yes, the process goes to step 303. Otherwise, the process loops back to step 301. In step 303, perform a normal e-mail sending or receiving via the mail processing module 123 and create data of e-mail encryption/decryption key to be sent. In step 304, it is determined whether the e-mail sending or receiving is completed. If yes, the process goes to step 305. Otherwise, the process loops back to step 303. Finally in step 305, the safe connection server 11 removes the virtual safe channel. The process performed by the mobile communication device 12 ends immediately.

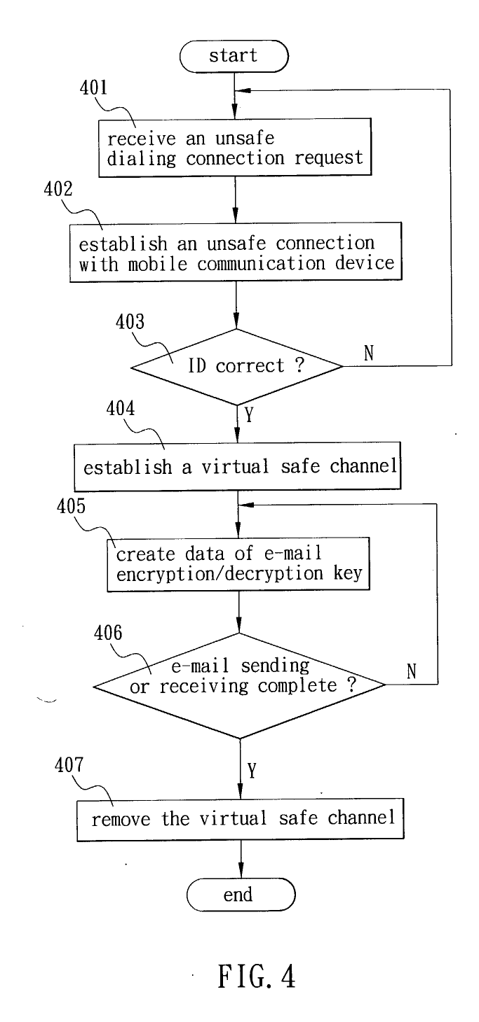

Referring to FIGS. 1 and 4, there is shown a flow chart performed by the mail server 10 according to the invention. It comprises the following steps:

In step 401, first the network connection module 101 receives the unsafe dialing connection request from the mobile communication device 12. In step 402, establish an unsafe connection with the mobile communication device 12 via the virtual connection module 102. In step 403, once connected, activate the safe connection server 11 so that the safe connection server 11 can determine whether identification (ID) and exchange encryption key are correct based on the address in the mobile communication device 12 and a corresponding address of the mail server 10. If yes, the process goes to step 404. Otherwise, the process loops back to step 401. In step 404, establish a virtual safe channel from the mobile communication device 12 to the mail server 10. In step 405, perform a normal e-mail sending or receiving via the mail processing module 103 and create data of e-mail encryption/decryption key to be sent. In step 406, it is determined whether the e-mail sending or receiving is completed. If yes, the process goes to step 407. Otherwise, the process loops back to step 405. Finally in step 407, the safe connection server 11 removes the virtual safe channel. The process performed by the mail server 10 ends immediately.

In brief, an e-mail is sent over a virtual safe channel established by the invention. Hence, scrambled codes are shown even if the e-mail is intercepted over the Internet by a third unauthorized person, i.e., unintelligible to the third unauthorized person. As an end, the purpose of protecting e-mails from being intercepted and/or overheard while sending is achieved.

While the invention has been described by means of specific embodiments, numerous modifications and variations could be made thereto by those skilled in the art without departing from the scope and spirit of the invention set forth in the claims.

What is claimed is:

1. A method of encrypting an e-mail comprising:
(a) providing a safe connection server in a mail server and an address in a mobile communication device for accessing the mail server;
(b) in response to a sending or receiving of the e-mail from the mobile communication device over the Internet, establishing a connection between the mobile communication device and the mail server;
(c) in response to a success of the connection, activating the safe connection server so that the safe connection server is capable of determining whether an ID and an exchange encryption key are correct based on the address in the mobile communication device and a corresponding address of the mail server;
(d) establishing a virtual safe channel from the mobile communication device to the mail server;
(e) encrypting the e-mail by adding an encryption key; and
(f) sequentially transmitting data contained in the encrypted e-mail over the virtual safe channel so as to carry out a normal e-mail sending or receiving via a mail processing module in the mobile communication device.

2. The method of claim 1, wherein:
the mail server comprises a network connection module for accessing the Internet, a virtual connection module for establishing a safe connection with the mobile communication device and maintaining the same, and a mail processing module for processing the e-mail;
the safe connection server is served to provide and connect to a safe channel, the safe connection server sharing a server with the mail server;
the mobile communication device is served to support a data dialing and an e-mail sending or receiving, the mobile communication device comprising a dialing connection module for establishing an unsafe connection with the Internet, a virtual connection module for establishing a safe connection with the mail server and maintaining the same, a mail processing module for sending or receiving the e-mail, and a mail provision module for providing messages about the mail server; and
the Internet is served to connect the mail server to the mobile communication device thereover.

3. The method of claim 1, wherein after all the packets being received to form a complete e-mail, the information stored in predetermined addresses of the encrypted e-mail comprises an IP header, the IP header being a data frame obtained by exchanging over the Internet, a safety protocol encryption header, the safety protocol encryption header being a data frame of safe channel protocol formed by encrypting, and a mail protocol data, the mail protocol data being a mail data formed by IP so that data content of each of the IP header, the safety protocol encryption header, and the mail protocol data of the encrypted e-mail is obtained by reading the respective predetermined address thereof.

4. The method of claim 3, wherein for sending or receiving the e-mail the mobile communication device performs the steps of:
(g) activating the dialing connection module to establish an unsafe dialing connection;
(h) establishing the virtual safe channel with the mail server based on the address in the mobile communication device via the virtual connection module;
(i) in response to the establishment of the virtual safe channel in the step (h), carrying out the normal e-mail sending or receiving via the mail processing module and creating data of an e-mail encryption/decryption key;
(j) after completing the e-mail sending or receiving, enabling the safe connection server to remove the virtual safe channel; and
(k) ending the steps performed by the mobile communication device.

5. The method of claim 3, wherein the mail server performs the steps of:
(l) enabling the network connection module to receive the unsafe dialing connection request from the mobile communication device;
(m) establishing the unsafe connection with the mobile communication device via the virtual connection module;
(n) after connecting, activating the safe connection server so that the safe connection server is capable of determining whether the ID and the exchange encryption key are correct based on the address in the mobile communication device and the corresponding address of the mail server;
(o) after determining the ID is correct, establishing the virtual safe channel from the mobile communication device to the mail server;
(p) carrying out the normal e-mail sending or receiving via the mail processing module and creating data of the e-mail encryption/decryption key;
(q) after completing the e-mail sending or receiving, enabling the safe connection server to remove the virtual safe channel; and
(r) ending the steps performed by the mail server.
